(19) United States
(12) Patent Application Publication
(10) Pub. No.: US 2005/0024566 A1
(43) Pub. Date: Feb. 3, 2005

(54) Apparatus and method for maintaining uniform contrast in liquid crystal displays

(76) Inventors: Donald M. MacIntyre, San Jose, CA (US); John M. MacIntyre, Lake Forest, CA (US); Yong Beom Kim, Alpharetta, GA (US)

Correspondence Address: HENRY M. STANLEY, 165 EAST HILTON DRIVE, BOULDER CREEK, CA, 95006, US

(21) Appl. No.: 10/902,354

(22) Filed: Jul. 28, 2004

Related U.S. Application Data
(60) Provisional application No. 60/492,094, filed on Jul. 31, 2003.

(51) Int. Cl. G02F 1/1333

(52) U.S. Cl. 349/122

(57) ABSTRACT

A liquid crystal display assembly contains a liquid crystal in a chamber formed between two plates and enclosed by a surrounding seal. Polarizer layers are attached to one or both plates, wherein the polarizer layers extend to the edges of the one or both plates. A uniform thickness adhesive layer is applied to the polarizer layers and additional layers are fixed by the adhesive to the assembly as required by the end purpose of the display. Curing of the uniform thickness adhesive layer results in uniform stress throughout the adhesive layer with resulting reduction of display assembly distortion.

This application claims priority on provisional patent application Ser. No. 60/492,094, filed Jul. 31, 2003.

### FIELD OF THE INVENTION

The invention herein relates to an improvement in a liquid crystal display.

### BACKGROUND OF THE INVENTION

Active matrix liquid crystal displays (AMLCD's) and passive matrix liquid crystal displays (PMLCD's) are known and typical descriptions of their uses and construction are seen in articles “AMLCD Manufacturing for Avionics Applications”, by Kalluri R. Sarma, pages 14-19, and “Electronic Aspects of AMLCD's”, by Song Soo Kim, pages 22-26, both articles appearing in the periodical “Information Display” dated August 2001, Volume 17, No. 8. A problem in liquid crystal displays exists wherein contrast across the length and breadth of the display is degraded in some display areas, such as near the display edges.

### SUMMARY OF THE INVENTION

A flat display panel has a front view plate with a predetermined peripheral shape. A back retention plate is provided and a seal extends between the front and back plates to form a closed chamber therebetween. A liquid crystal is placed within the chamber. A first polarizer layer is fixed to the front view plate wherein the first polarizer has a peripheral shape that extends to, or is in registration with, the edges of the front view plate. A top display plate is provided adjacent the first polarizer layer and attached thereto by a uniformly thick first adhesive layer.

A flat panel liquid crystal display includes a front glass plate with an outer and an inner surface and a predetermined peripheral shape. A back plate also has an outer and an inner surface and a seal extends between the inner surfaces of the front and back plates to enclose a chamber therebetween. A liquid crystal fills the enclosed chamber. A first polarizer layer is fixed to the front glass plate outer surface, having a peripheral shape in registration with the first predetermined peripheral shape. A top plate is adjacent to and spaced from the first polarizing layer and a uniformly thick first adhesive layer is disposed between the top plate and the first polarizer layer.

A flat panel display includes a top plate having an upper surface as well as a first predetermined peripheral shape. A bottom glass plate has a lower surface and a second predetermined peripheral shape. A seal extends between the top and bottom glass plates and encloses a chamber between the plates. A liquid crystal fills the chamber. A first polarizer layer is fixed to the upper surface of the top glass plate, wherein the polarizer layer has a peripheral shape matching the first predetermined peripheral shape. An upper plate is positioned adjacent to the first polarizer layer. A second polarizer layer is fixed to the bottom glass plate lower surface that has a peripheral shape matching the second predetermined peripheral shape. A lower plate is positioned adjacent the second polarizer layer. First and second substantially uniformly thick adhesive layers are disposed to fix the first polarizer layer to the upper plate and the second polarizer layer to the lower plate, so that after curing the first and second adhesive layers uniform stress exists throughout the first and second adhesive layers.

The method of the present invention for assembling a uniform contrast liquid crystal display relates to an initial assembly having upper and lower glass layers with predetermined peripheral shapes and a seal between the upper and lower layers that defines a chamber containing a liquid crystal. The method includes the steps of shaping a full dimensioned polarizer layer having the predetermined peripheral shape of the upper glass layer, and applying the full dimensioned polarizer to the upper glass layer. Further, a uniformly thick adhesive layer is laid on the exposed surface of the full dimensioned polarizer. A top display layer is placed on the adhesive layer and the uniformly thick adhesive layer is cured so that substantially uniform stress exists throughout the adhesive layer.

### BRIEF DESCRIPTION OF THE DRAWINGS

FIG. 1 is a section labeled “Old Art”.

FIG. 2 is a section illustrating the registration of the edges of the polarizer layer and the plates that confine the liquid crystal.

FIG. 3 is a flow chart illustrating the method of the present invention.

FIG. 4 is a flow chart showing details of the curing steps in the present invention.

### DESCRIPTION OF THE PREFERRED EMBODIMENTS

A liquid crystal display is a “light valve” that selectively allows passage of light in accordance with signals supplied to the display matrix wherein the passed light forms a recognizable pattern. In certain circumstances display contrast degradation may cause a loss of vital display information. The invention involving the structure and process described herein addresses and resolves this problem.

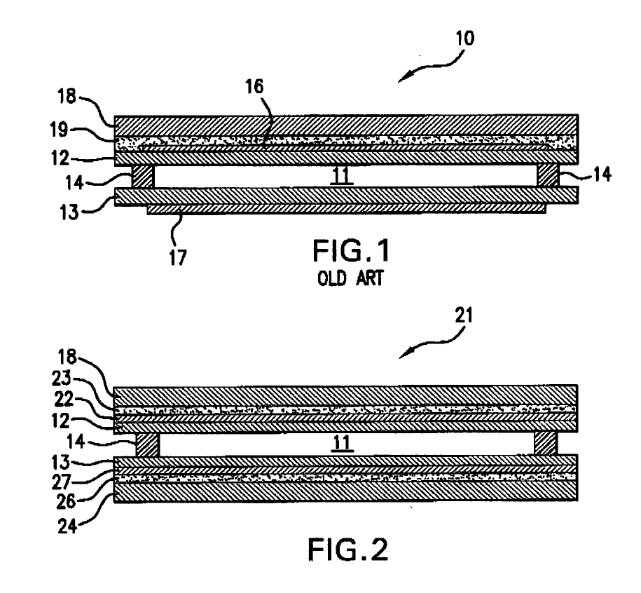

The section of FIG. 1 illustrates an assembly 10 that includes a rudimentary stack of components forming a liquid crystal display panel that is available from a number of providers such as NEC or Sharp, both having offices in San Jose, Calif. In FIG. 1 a chamber 11 containing liquid crystal and other components, some of which are described in the article by Sang Soo Kim (Information Display periodical) mentioned herein, is surrounded as shown by an upper glass layer 12, by a lower glass layer 13 and by a surrounding seal 14 extending between items 12 and 13. An upper polarizer layer 16 is secured by a contact adhesive layer thereon to the upper glass layer 12. A lower polarizer layer 17 is secured by a contact adhesive layer thereon to the lower glass layer 13. The combination of chamber 11, layers 12, 13, 16, and 17 and the seal 14 forms the previously mentioned rudimentary liquid crystal display or LCD panel within the assembly 10.

Assembly 10 also includes a layer 18 that provides functions necessary to performance of the end purpose of the display assembly. The layer 18 is obtained from a number of providers, including applied Films Lab, Inc. of Boulder, Colo. Layer 18 is secured in place in assembly 10 by an adhesive layer 19. One adhesive used successfully in this application is EPO-TEK-301-2FL, obtained from Epoxy Technology of Billerica, Mass. It should be noted in FIG. 1 that polarizer layer 16 does not extend to the edge of layer 12. Therefore, the thickness of the adhesive layer is greater near the layer's edge than it is in the region immediately between layers 16 and 18. During curing of adhesive layer 19 a stress is induced in the thicker edges of the adhesive layer that is greater than that throughout the remainder of the layer. The non-uniform stress operates on the upper glass layer 12 to change the dimension between the facing surfaces at the edges of the glass layers 12 and 13. The change in dimension causes a change in the light valving function of the liquid crystal in chamber 11. This change manifests itself in the form of light leakage and contrast in the display is therefore degraded Turning to FIG. 2 of the drawings, an assembly 21 is shown wherein the chamber 11, with its included components, the seal 14 and the layers 12, 13, and 18, are substantially the same as described for assembly 10. However, it should be noted that an upper polarizer layer 22 is secured to upper glass layer 12 wherein the polarizer layer 22 extends to the edges of glass layer 12. An adhesive layer 23 is now shown between layer 22 and the layer 18. The adhesive layer is of the same material as layer 19 (FIG. 1); i.e., EOP-TEK 301-2FL. Adhesive layer 23 is of uniform thickness as seen, thereby avoiding the creation of non-uniform stress in the adhesive layer during the adhesive curing process steps. With a substantially uniform stress throughout the adhesive layer 23 the glass layer 12 is not deformed at the edges and the separation distance between the facing surfaces of glass layers 12 and 13 is not changed. As a result, contrast is maintained uniformly from edge to edge in the display provided by the assembly 21.

FIG. 2 also shows a layer 24 attached to the underside of assembly 21. Layer 24 performs functions, to be hereinafter described, that are similar to those performed by layer 18. Layer 24 is applied to the assembly of FIG. 2 by an adhesive layer 26. Note that a polarizer layer 27 is now fixed to the lower glass layer 13 and that layer 27 extends to the edges of glass layer 13. Since polarizer layer 27 is configured substantially the same as polarizer layer 22, the adhesive layer 26 is of uniform thickness. Non-uniform stress, therefore, does not arise during the curing cycle for the adhesive and as a result uniform contrast is maintained from edge to edge in the display lower portion as previously explained with regard to the upper portion of the display of FIG. 2. It should be realized that the polarizer layer 27 and glass layer 24 are optional and are present only when the purpose and operating environment of the assembly 21 require them.

The layers 18 and 24 carry additional components and coatings that perform a number of functions. Generally these layers serve to strengthen or ruggedize the assemblies 10 and 21. Upper or front glass layer 18 may be referred to as an optical filter or cover glass. Either of these layers may have a conductive coating applied to transfer stray EMI signals to ground or they may carry heaters. Anti-reflection coatings are also applied to layers 18 and 24 when required. A combination of functions may be performed by applying a combination of EMI, anti-reflection and heater coatings, for example. Additionally, certain protective films are applied to various assembly components during manufacturing processing and removed when no longer needed. These additional components and protective films are known and not described in detail here.

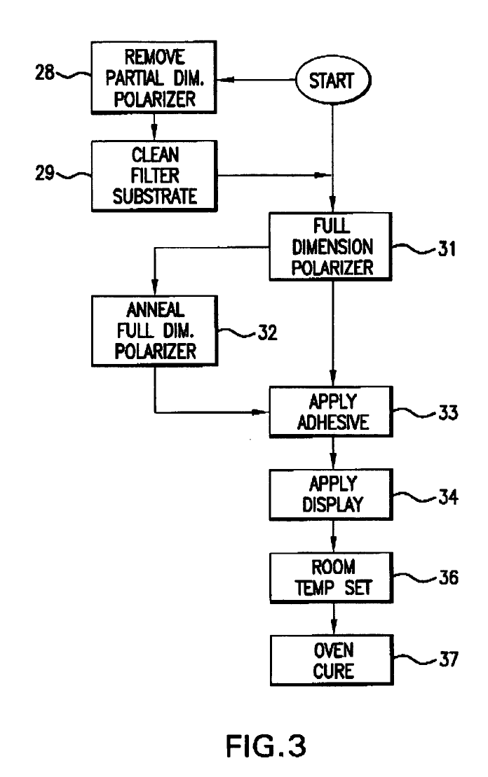

FIG. 3 is a block diagram representing steps in the process for assembling the components to obtain the results provided by the described invention. The liquid crystal display panel contains liquid crystal and other components in chamber 11, upper and lower glass layers 12 and 13, seal 14 and polarizer layers 16 and 17 as seen in FIG. 1. When the liquid crystal display panel has upper and lower polarizer layers 16 and 17 as portrayed in FIG. 1, the upper polarizer layer 16, referred to as a partial dimensioned polarizer, is removed as represented by step 28 in FIG. 3. The exposed surface of upper glass layer 12 is cleaned to remove all residue in step 29. The full dimensioned upper polarizer layer 22, as seen in FIG. 2, is applied in step 31, with the polarity of layer 22 in predetermined orientation and relying on the contact adhesive on the polarizer to fix it in place. Polarized film for use in this invention is available from Nitto Danko America Inc., with offices in New Brunswick, N.J. It is necessary in some instances to anneal the applied full dimensioned polarizer 22 to remove stress in the layer as seen in step 32. If the annealing step is necessary, one manner of annealing is to submit the liquid crystal panel with layer 22 attached to a 70 degree C. environment for one hour.

As seen in FIG. 3 the next step in the process is to apply adhesive, such as EPO-TEK 301-2FL previously mentioned, as in step 33. At present, a line of adhesive a few millimeters wide is laid across one dimension of the full dimensioned polarizer layer 22. The line of adhesive is carefully inspected to assure that there are no bubbles or impurities in the adhesive. The glass layer 18 is then carefully positioned, as in step 34, on top of the polarizer 22. The assembly is set at room temperature in step 26 for about two hours. During this last mentioned step the adhesive spreads out in a uniformly thick layer (FIG. 2, item 23) between the glass layer 18 and the full dimensioned polarizer layer 22. The adhesive fills the entire space between the adjacent layers and the excess adhesive is removed from the edges of the assembly. The assembly 21 is then submitted to an oven cure as shown at 37 in FIG. 3.

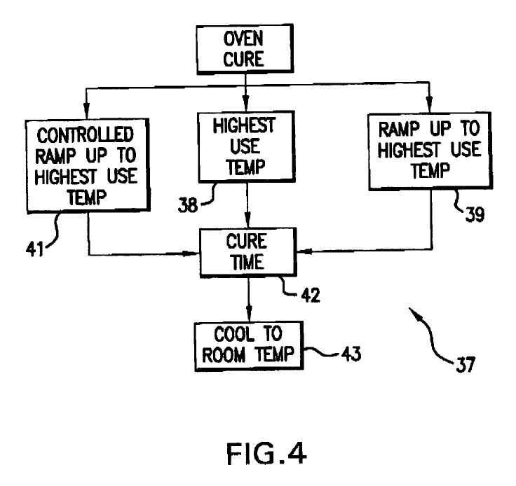

The details of the oven cure 37 in a preferred embodiment are shown in FIG. 4. The assembly 21 is subjected to the highest temperature to be encountered in its intended use environment in step 38. The cure temperature may typically be 65 degrees C. or, for avionics applications for example, may be as high as 100 degrees C. As an alternative to placing the assembly in a preheated oven at the highest intended use temperature, the oven containing the assembly to be cured may be ramped up to the desired temperature as seen in step 39. An additional alternative in the process is to control the ramp-up at a predetermined rate of temperature increase, such as one half degree C. per minute, as seen in step 41. The cure time in step 42 is, in one embodiment, about five hours. At the end of the adhesive cure time the oven is allowed to cool to room temperature as shown in process step 43 of FIG. 4.

The foregoing process is used for all current display sizes and for each side, top and bottom as seen in FIGS. 1 and 2. If the finished assembly is to reach the form of the assembly 21 in FIG. 2, the process will involve removal of polarizer layer 17 (FIG. 1), replacement by polarizing layer 27 (FIG. 2) and placement of glass plate 24 by means of adhesive layer 26. As previously described, the stress free or uniformly stressed adhesive layers 22 and 26 do not distort or alter the relative positions of the glass layers 12 and 13, thereby resulting in uniform contrast across the entire face of the assembly displays.

Although the best mode contemplated for carrying out the present invention has been shown and described herein, it will be understood that modification and variation may be made without departing from what is regarded to be the subject matter of the invention.

1. A flat display panel, comprising
a front view plate having a first predetermined peripheral shape,
a back retention plate,
a seal extending between said front and back plates and enclosing a chamber therebetween,
a liquid crystal disposed within said chamber,
a first polarizer layer affixed to said front view plate and having a peripheral shape substantially in registration with said first predetermined peripheral shape,
a display top plate adjacent to said first polarizer layer, and
a substantially uniformly thick first adhesive layer disposed between said display top plate and said first polarizer layer, so that during first adhesive layer curing uniform stress is present within said first adhesive layer.

2. A flat display panel as in claim 1, wherein said back retention plate has a second predetermined peripheral shape, further comprising
a second polarizer layer affixed to said back retention plate and having a peripheral shape substantially in registration with said second predetermined peripheral shape,
a display rear plate adjacent to said second polarizer layer, and
a substantially uniformly thick second adhesive layer disposed between said display rear plate and said second polarizer layer, so that during adhesive layer curing uniform stress is present within said second adhesive layer.

3. A flat panel liquid crystal display, comprising
a front glass plate having an outer surface and an inner surface and having a first predetermined peripheral shape,
a back plate having an outer surface and an inner surface,
a seal extending between said inner surfaces of said front glass plate and said back plate and enclosing a chamber therebetween,
a liquid crystal filling said chamber,
a first polarizer layer fixed to said front glass plate outer surface and having a peripheral shape substantially in registration with said first predetermined peripheral shape,
a top plate adjacent to and spaced from said first polarizing layer, and
a substantially uniformly thick first adhesive layer disposed between said top plate and said first polarizer layer, so that during first adhesive layer curing uniform stress is present throughout said first adhesive layer.

4. A flat panel liquid crystal display as in claim 3, wherein said back plate has a second predetermined peripheral shape, further comprising
a second polarizer layer fixed to said back plate outer surface and having a peripheral shape substantially in registration with said second predetermined peripheral shape,
a rear plate adjacent to and spaced from said second polarizer layer, and
a substantially uniformly thick second adhesive layer disposed between said rear plate and said second polarizer layer outer surface, so that during adhesive curing uniform stress is present throughout said second adhesive layer.

5. A flat panel display, comprising
a top glass plate having an upper surface and a first predetermined peripheral shape,
a bottom glass plate having a lower surface and a second predetermined peripheral shape,
a seal between said top and bottom glass plates and enclosing a chamber therebetween,
a liquid crystal disposed in said chamber,
a first polarizer layer affixed to said top glass plate upper surface, and having a peripheral shape in registration with said first predetermined peripheral shape,
an upper plate adjacent to said first polarizer layer,
a second polarizer layer affixed to said bottom glass plate lower surface and having a peripheral shape in registration with said second predetermined peripheral shape,
a lower plate adjacent to said second polarizer layer, and
first and second substantially uniformly thick adhesive layers fixing said first polarizer layer to said upper plate and said second polarizer layer to said lower plate respectively, whereby uniform stress is maintained within said first and second adhesive layers when cured.

6. A method of assembling a uniform contrast liquid crystal display utilizing an initial assembly of upper and lower glass layers having predetermined peripheral shapes and a seal between the upper and lower layers to define a closed chamber containing a liquid crystal, comprising the steps of
shaping a full dimensioned polarizer layer having substantially the predetermined peripheral shape of the upper glass layer,
applying the full dimensioned polarizer to the upper glass layer,
laying a uniformly thick adhesive layer on the exposed surface of the full dimensioned polarizer,
placing a top display layer on the adhesive layer, and
curing the uniformly thick adhesive layer so that substantially uniform stress exists throughout the adhesive layer.

7. A method as in claim 6, further comprising the steps of
shaping an additional full dimensional polarizer having substantially the predetermine peripheral shape of the lower glass layer,
applying the additional full dimensional polarizer to the lower glass layer,
applying an additional uniformly thick adhesive layer to the exposed surface of the additional full dimensional polarizer,
placing a bottom display layer on the additional uniformly thick adhesive layer, and
curing the additional uniformly thick adhesive layer so that substantially uniform stress exists throughout the additional adhesive layer.
